(19) United States
(12) Patent Application Publication
(10) Pub. No.: US 2026/0171646 A1
(43) Pub. Date: Jun. 18, 2026

(54) ANTENNA MOUNT

(71) Applicant: FUBA Automotive Electronics GmbH, Bad Salzdetfurth (DE)

(72) Inventors: Joshua Weichenhain, Bockenem (DE); Sergej Kiricenko, Hannover (DE)

(21) Appl. No.: 19/416,484

(22) Filed: Dec. 11, 2025

(30) Foreign Application Priority Data
Dec. 12, 2024 (DE) 102024137518.3

(51) Int. Cl. H01Q 1/12; H01Q 1/20

(52) U.S. Cl. CPC H01Q 1/1207; H01Q 1/20

(57) ABSTRACT

An antenna mount for assembly in a recess of a planar component comprises an antenna foot; a retaining bracket having an inner surface facing the antenna foot and an outer surface opposite the inner surface; and a fastening element having a fastening axis for fastening the retaining bracket to the antenna foot. The retaining bracket has a base and a plurality of spreading legs extending from the base. The antenna foot has at least one spreading surface which is inclined with respect to the fastening axis and along which the inner surfaces of the spreading legs slide on an assembly of the antenna mount in order to effect a radial spreading apart of the spreading legs.

The invention relates to an antenna mount for assembly in a recess of a planar component.

Such antenna mounts are known, for example, for fixing vehicle antennas to a vehicle body. The antenna mounts are placed from the outside against a recess in the vehicle body and are fixed from an inner vehicle side in the recess using a fastening means that is supported at the vehicle body.

It is the object of the present invention to provide an antenna mount that can be assembled in a particularly simple manner and that can be manufactured in a cost-effective manner.

This object is satisfied by an antenna mount having the features of claim 1. The antenna mount for assembly in a recess of a planar component comprises an antenna foot; a retaining bracket having an inner surface facing the antenna foot and an outer surface opposite the inner surface; and a fastening element having a fastening axis for fastening the retaining bracket to the antenna foot. The retaining bracket has a base and a plurality of spreading legs extending from the base. The antenna foot has at least one spreading surface which is inclined with respect to the fastening axis and along which the inner surfaces of the spreading legs slide on an assembly of the antenna mount in order to effect a radial spreading apart of the spreading legs.

The antenna mount according to the invention can be manufactured very cost-effectively since the foot simultaneously serves as a spreading element for the retaining bracket and no additional component is required for spreading apart the spreading legs of the retaining bracket. The assembly takes place by actuating the fastening element that presses the base of the retaining bracket in the direction of the fastening axis towards the antenna foot, whereby the spreading legs slide along the spreading surface and a spreading apart of the spreading legs takes place. As a result, the spreading legs come into contact with the planar component, support themselves thereat and thereby fix the antenna mount to the planar component. Accordingly, the assembly takes place quickly and easily since few components have to be fastened to the antenna mount and the antenna mount is assembled at the recess simply by actuating the fastening element.

Advantageous embodiments and further developments of the invention are described in the description, in the drawings and in the dependent claims.

In a first advantageous embodiment, the spreading legs are S-shaped, whereby good elastic properties of the spreading legs are achieved and a permanently uniform contact pressure of the spreading legs at the planar component can be ensured.

According to a further advantageous embodiment, each spreading leg has a straight center section whose two ends are adjoined by curved sections, which produces a particularly favorable bending behavior.

According to a further advantageous embodiment, each spreading leg has a shoulder section that is curved towards the inner surface and that extends from the base first in a radial direction and then in the direction of the antenna foot. Due to the shoulder sections curved towards the inner surface, the retaining bracket has a relatively small periphery in the radial direction before the spreading apart so that the antenna foot with the retaining bracket fastened thereto fits through the recess. Moreover, since the spreading legs extend from the base in the direction of the antenna foot, the free ends of the spreading legs are already in the immediate vicinity of the planar component before the spreading apart, whereby the deformation of the spreading legs that is necessary for contacting the planar component can be kept relatively low.

According to a further advantageous embodiment, each spreading leg has, in the region of its free end, a curved section that has a convex inner surface, viewed in a longitudinal section of the spreading leg.

In this way, similarly to with bent-up skip tips, the free ends are prevented from impacting the spreading surfaces or the planar component at an unfavorable angle during the assembly and from getting caught at or piercing into said spreading surfaces or planar component, which could lead to an increased frictional resistance or even to damage to the planar component. In contrast, due to the convex inner surface of the curved section, the free ends impact the sliding surfaces at a more favorable angle, whereby a uniform sliding movement of the spreading legs is achieved and a simple and smooth assembly of the antenna mount can be ensured. Furthermore, loads can be avoided that can act on the planar component through increased frictional forces and can lead to deformations.

According to a further advantageous embodiment, the inner surface of each spreading leg, at the free end thereof, is formed concave, viewed in a cross-section of the spreading leg.

In this respect, the inner surfaces of the spreading legs do not come into contact with the planar component across the entire width, but only with the marginal sections of the inner surfaces. This results in a lower frictional resistance, whereby less force has to be applied during the fastening and damage to the planar component can be reliably avoided.

According to a further advantageous embodiment, each spreading leg has, at its free end at its inner surface, a groove having two marginal edges that extend in the longitudinal direction of the spreading leg and that serve as a contact section for the planar component.

Similar to the principle of an ice-skate blade, excellent sliding properties of the inner surfaces of the spreading legs are hereby achieved, wherein it is simultaneously achieved that the marginal edges slightly score into the planar component and thereby establish a galvanic contact therewith.

According to a further advantageous embodiment, edges of the spreading legs extend in the longitudinal direction at the inner surface and, in the region of the free end, are formed by an acute angle between the inner surface and a respective side surface that bounds the spreading leg in the width direction.

The edges hereby also form two cutting edges that extend in the longitudinal direction and that reliably penetrate a paint layer applied to the planar component. An electrical contact can thereby be reliably established with the planar component and, for example, serves as a ground contact for an antenna.

According to a further advantageous embodiment, each spreading leg has a taper which is formed in the shoulder section and at which in particular a dimension of the spreading leg is reduced in the width direction.

Due to the taper, both a force that has to be applied to spread apart the spreading legs and a force that is applied to the planar component at the contact points by the spreading legs can be specifically influenced, which can further simplify the assembly.

According to a further advantageous embodiment, the antenna foot has a separate spreading surface for each spreading leg. As a result, the space occupied by the spreading surface at the antenna foot can be reduced and more flexible design options for the antenna foot result in order, for example, to be able to adapt the antenna foot to a geometry of the recess.

According to a further advantageous embodiment, at least one surface section of the antenna foot is configured as an abutment surface for a spreading leg for security against rotation. An even more simple assembly can hereby be achieved since a rotation of the retaining bracket can be reliably suppressed during the fastening without having to additionally hold the retaining bracket in position. Furthermore, the positions of the contact points between the retaining bracket and the planar component can thus be determined in advance.

Further aspects of the present invention also relate to a vehicle antenna comprising an antenna mount of the kind described above and to a vehicle comprising a planar component at which an antenna mount of the kind described above is assembled, wherein the two marginal edges contact the planar component under a preload. It is understood that the vehicle antenna described herein is also suitable for aircraft and watercraft.

The present invention will be described in the following purely by way of example with reference to an advantageous embodiment and to the enclosed drawings. There are shown:

FIG. 1 a perspective view of an antenna mount in a pre-assembled state;

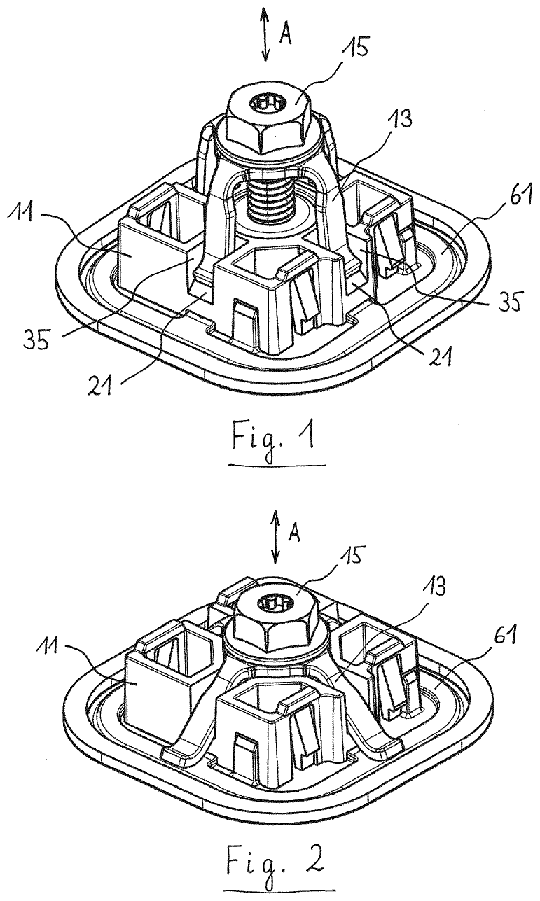

FIG. 2 a perspective view of the antenna mount in an assembled state;

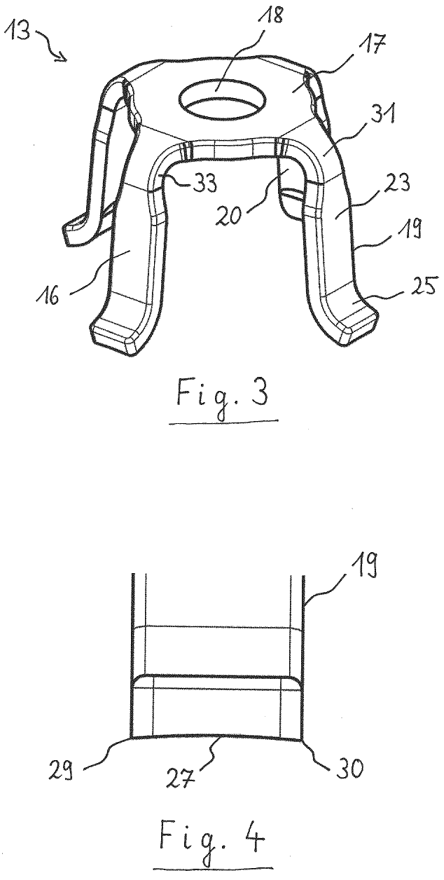

FIG. 3 a perspective view of the retaining bracket of the antenna mount of FIGS. 1 and 2; and

FIG. 4 an enlarged part representation of the retaining bracket of FIG. 3 in a front view.

FIGS. 1 and 2 show an antenna mount comprising an antenna foot 11, a retaining bracket 13 and a fastening element 15. The antenna mount is arranged in a recess of a planar component 61. The planar component 61 can, for example, be part of a body of a vehicle, e.g. a vehicle roof. The antenna mount can, in the interior, receive electrical and/or electronic components and can comprise a fastening device for an antenna or can comprise an antenna itself. In each of the views of FIGS. 1 and 2, an inner vehicle surface of the body 61 can be seen. The antenna foot 11 projects at least partly through the recess in the direction of the inner vehicle side.

As FIGS. 1 and 2 show, the fastening element 15 in the embodiment example shown is designed as a screw 15 that interacts with an internal thread of the antenna mount and that can be screwed in or unscrewed along a fastening axis A.

FIG. 3 shows the retaining bracket 13 as a single component that, in the embodiment example, is made of metal and is configured as a stamped and bent part. The retaining bracket 13 is formed by a base 17 and a plurality of spreading legs 19 extending from the base. In the embodiment example shown, the base 17 is a planar surface component from whose corners four spreading legs extend that are formed at the base 17 at equal distances from one another. The base 17 comprises a centrally arranged circular opening 18 which is passed through by the base 17 in the thickness direction and which serves as a passage for the screw 15.

The retaining bracket 13 has an outer surface, an inner surface and a side surface. The outer surface is formed by the upper surface of the base 17 shown in FIG. 3 and the adjoining outer surfaces 16 of the spreading legs 19. The inner surface is formed by the lower surface of the base 17, which is not visible in FIG. 3, and by the adjoining inner surfaces 20 of the spreading legs 19 that are partly visible in FIG. 3. The side surface extends from the margins of the outer surface to the margins of the inner surface in the thickness direction of the retaining bracket 13. As can be seen in FIGS. 1 and 2, the retaining bracket 13 is fastened to the antenna foot such that the inner surface, in particular the inner surface of the base 17, faces the antenna foot 11.

The spreading legs 19 are substantially S-shaped, wherein each spreading leg 19 has a curved shoulder section 31 extending from the base 17, a straight center section 23 and a curved section 25 that is adjoined by the free end of the spreading leg 19. As FIG. 3 shows, the shoulder section 31 is curved towards the inner surface. The curved section 25, on the other hand, is curved towards the outer surface. This means that the curvature of the curved section 25 is oriented inversely to the curvature of the shoulder section 31 so that the spreading leg 19 has a turning point in the curvature behavior and thus forms the S shape.

Due to the curvature of the shoulder section 31, the straight center section 23 extends at an angle to the base 17. This angle can amount to approximately 90° to 100°, in particular approximately 95°, in the non-spread-apart state. Due to the curvature of the curved section 25, the free end extends at an angle to the straight center section 23. This angle can amount to approximately 102° to 118°, in particular approximately 114°. Due to the curved section 25, each spreading leg 19 has, in the region of the free end, a convex inner surface 20, viewed in a longitudinal section of the spreading leg.

Each spreading leg 19 has a taper 33 in the region of the shoulder section 31 and in a part region of the center section 23, at which taper a dimension of the spreading leg 19 is reduced in the width direction. Due to the taper 33, it can be achieved that a force that has to be applied to spread apart the spreading legs 19 becomes smaller.

FIG. 4 shows, in an enlarged partial view of FIG. 3, a free end of a spreading leg 19 in a front view. As can be seen in FIG. 4, at the inner surface 20 in the region of the free end of the spreading leg 19, a groove 27 is formed that has two marginal edges 29, 30 that extend in the longitudinal direction of the spreading leg 19. The groove 27 and the two marginal edges 29, 30 can extend from the free end up to completely or partly over the curved section 25. Due to the groove 27, the inner surface 20 is formed concave at the free end, viewed in a cross-section of the spreading leg 19. Furthermore, due to the provision of the groove 27 in the region of the free end, the marginal edges 29, 30 extending in the longitudinal direction at the inner surface 20 are formed by an acute angle (i.e. <90°) between the inner surface 20 and the respective side surface section.

As FIGS. 1 and 2 show, the antenna foot 11 in the embodiment example shown has, in a plan view, an approximately square basic shape that can substantially correspond to a geometric shape of the recess in the body 61. A spreading surface 21, which is inclined with respect to the fastening axis A, is formed at each side of the antenna foot 11 Thus, the antenna foot 11 has a total of four spreading surfaces 21 in the embodiment example. The spreading surfaces 21 are inclined such that they move away from the fastening axis A in the screwing-in direction of the screw 15.

FIG. 1 shows the pre-assembled state in which the retaining bracket 13 is fastened to the antenna foot 11, wherein the base 17 is, however, arranged at a distance from the antenna foot 11 and no spreading apart of the spreading legs 19 has yet taken place or only a slight spreading apart has taken place. As can be seen in FIG. 1, the arrangement of the spreading surfaces 21 at the antenna foot 11 matches the arrangement of the spreading legs 19 at the retaining bracket 13 such that, in the pre-assembled state, the inner surfaces 20 of the spreading legs 19 contact the spreading surfaces 21 in the region of the free ends.

As FIG. 1 and FIG. 2 show, the antenna foot 11 furthermore has a plurality of surface sections 35 for securing the retaining bracket 13 against rotation, said surface sections 35 serving as abutment surfaces for the spreading legs 19 contacting the spreading surfaces 21. In the embodiment example shown, the surface sections 35 are formed by flanks of the antenna foot 11 that are perpendicular to the spreading surfaces 21 and that extend substantially parallel to the fastening axis A. The surface sections 35 limit or prevent a rotational movement of the retaining bracket 13 about the fastening axis A.

The assembly of the antenna mount described above by way of example is explained in more detail in the following.

As already mentioned above, FIG. 1 shows the antenna mount in the pre-assembled state. In this respect, the retaining bracket 13 is fixed to the antenna foot 11 by the screw 15 in a state in which a screw head of the screw 15 contacts the outer surface of the base 17 and the base 17 is arranged at a distance from the antenna foot.

Furthermore, the inner surfaces 20 of the spreading legs 19 contact the spreading surfaces 21 of the antenna foot 11 in the region of the free ends, wherein no spreading apart of the spreading legs 19 has yet taken place or only a slight spreading apart has taken place. In particular, in this state, the free ends of the spreading legs 19 do not project beyond an outer periphery of the antenna foot 11 in a plan view. In the pre-assembled state, the antenna mount can hereby be arranged from an outer vehicle side at the recess of the body 61 and the antenna foot 11 can be inserted through the recess together with the already fastened retaining bracket 13.

The fixing of the antenna mount in the recess of the body 61 takes place by actuating the screw 15 in the screwing-in direction, whereby the base 17 of the retaining bracket 13 is pressed along the fastening axis A in the direction of the antenna foot 11. In the embodiment example shown, the fastening axis A is oriented substantially perpendicular to the inner vehicle surface of the body 61 surrounding the recess. A co-rotation or twisting of the retaining bracket 13 during the screwing in is limited or prevented by the surface sections 35 of the antenna foot since they serve as abutment surfaces for the spreading legs 19. While the base 17 is pressed towards the antenna foot 11 by the screwing in of the screw 15, the spreading legs 19 of the retaining bracket 13 slide along the spreading surfaces 21 and a spreading apart of the spreading legs 19 in the radial direction, i.e. substantially perpendicular to the fastening axis A, takes place.

In the further course of the assembly, the inner surfaces 20 of the spreading legs 19, which continue to spread apart, come into contact with and slide along the inner vehicle surface of the body 61 in the region of the free ends until the assembled state shown in FIG. 2 is reached. In this state, the base 17 contacts the antenna foot 11 and is held in this position by the screw 15. The inner surfaces 20 of the spreading legs 19 are in contact with the body 61 in the region of the free ends and are supported at said body. The antenna mount is hereby fixed in the recess of the body 61.

Due to the curved sections 25 and the thereby formed convex inner surfaces 20 of the spreading legs 19, the sliding properties of the spreading legs 19 at the spreading surfaces 21 and at the inner vehicle surface of the vehicle body 61 are improved. In particular, the free ends are prevented from impacting the spreading surfaces 21 or the inner vehicle surface of the body 61 at an unfavorable angle during the assembly and from getting caught at or piercing into said spreading surfaces or inner vehicle surface, which would lead to an increased frictional resistance and a thereby increased required force for actuating the screw or even to damage to the body 61. On the other hand, in the embodiment example described, a uniform sliding movement of the spreading legs 19 and consequently a simple and smooth assembly of the antenna mount can be ensured. Furthermore, loads can be avoided that act on the body 61 through increased frictional forces and that can lead to deformations at the body 61.

As mentioned above, in the embodiment example shown, in the region of the free ends, the inner surfaces 20 of the spreading legs 19 are provided with the groove and the two marginal edges 29, 30 that form two cutting edges extending in the longitudinal direction of the spreading legs 19. Said cutting edges serve as a contact section for the body 61. Thus, the spreading legs 19 do not come into contact with the body 61 across the entire width, but rather only in the region of the cutting edges, similarly to an ice-skate blade. The sliding properties of the spreading legs 19 at the body 61 can thereby be further improved. Furthermore, the cutting edges can penetrate a paint layer on the body 61 during the assembly of the antenna mount and can thus reliably establish an electrically conductive connection between the antenna mount and the body 61 without further assembly steps having to take place.

It is understood that the specific embodiment of the antenna mount described above is purely exemplary and that the antenna foot 11 and the retaining bracket 13 can generally have any desired shapes.

1-13. (canceled)

14. An antenna mount for assembly in a recess of a planar component, said antenna mount comprising
an antenna foot;
a retaining bracket having an inner surface facing the antenna foot and an outer surface opposite the inner surface; and
a fastening element having a fastening axis for fastening the retaining bracket to the antenna foot, wherein
the retaining bracket has a base and a plurality of spreading legs extending from the base, and
the antenna foot has at least one spreading surface which is inclined with respect to the fastening axis and along which the inner surfaces of the spreading legs slide on an assembly of the antenna mount in order to effect a radial spreading apart of the spreading legs.

15. The antenna mount according to claim 14,
wherein the spreading legs are S-shaped.

16. The antenna mount according to claim 14,
wherein each spreading leg has a straight center section whose two ends are adjoined by curved sections.

17. The antenna mount according to claim 14,
wherein each spreading leg has a shoulder section that is curved towards the inner surface and that extends from the base first in a radial direction and then in the direction of the antenna foot.

18. The antenna mount according to claim 14,
wherein each spreading leg has, in the region of its free end, a curved section that has a convex inner surface, viewed in a longitudinal section of the spreading leg.

19. The antenna mount according to claim 14,
wherein the inner surface of each spreading leg, at the free end thereof, is formed concave, viewed in a cross-section of the spreading leg.

20. The antenna mount according to claim 14,
wherein each spreading leg has, at its free end at its inner surface, a groove having two marginal edges that extend in the longitudinal direction of the spreading leg and that serve as a contact section for the planar component.

21. The antenna mount according to claim 14,
wherein edges of the spreading legs extend in the longitudinal direction at the inner surface and, in the region of the free end, are formed by an acute angle between the inner surface and a respective side surface that bounds the spreading leg in the width direction.

22. The antenna mount according to claim 17,
wherein each spreading leg has a taper which is formed in the shoulder section.

23. The antenna mount according to claim 22,
wherein a dimension of the spreading leg is reduced in the width direction at the taper.

24. The antenna mount according to claim 14,
wherein the antenna foot has a separate spreading surface for each spreading leg.

25. The antenna mount according to claim 14,
wherein at least one surface section of the antenna foot is configured as an abutment surface for a spreading leg for security against rotation.

26. A vehicle antenna comprising an antenna mount, said antenna mount comprising
an antenna foot;
a retaining bracket having an inner surface facing the antenna foot and an outer surface opposite the inner surface; and
a fastening element having a fastening axis for fastening the retaining bracket to the antenna foot, wherein
the retaining bracket has a base and a plurality of spreading legs extending from the base, and
the antenna foot has at least one spreading surface which is inclined with respect to the fastening axis and along which the inner surfaces of the spreading legs slide on an assembly of the antenna mount in order to effect a radial spreading apart of the spreading legs. (New) A vehicle comprising a planar component at which an antenna mount is assembled, said antenna mount comprising
an antenna foot;
a retaining bracket having an inner surface facing the antenna foot and an outer surface opposite the inner surface; and
a fastening element having a fastening axis for fastening the retaining bracket to the antenna foot, wherein
the retaining bracket has a base and a plurality of spreading legs extending from the base, and
the antenna foot has at least one spreading surface which is inclined with respect to the fastening axis and along which the inner surfaces of the spreading legs slide on an assembly of the antenna mount in order to effect a radial spreading apart of the spreading legs, wherein each spreading leg has, at its free end at its inner surface, a groove having two marginal edges that extend in the longitudinal direction of the spreading leg and that serve as a contact section for the planar component, and wherein the two marginal edges contact the planar component under a preload.
